(19) United States
(12) Patent Application Publication
(10) Pub. No.: US 2004/0121181 A1
(43) Pub. Date: Jun. 24, 2004

(54) System for protection of submerged marine surfaces

(76) Inventor: Edwin Young Call, Virginia Beach, VA (US)

Correspondence Address: SMITH, GAMBRELL & RUSSELL, LLP, 1850 M STREET, N.W., SUITE 800, WASHINGTON, DC, 20036, US

(21) Appl. No.: 10/089,315

(22) PCT Filed: May 1, 2001
(86) PCT No.: PCT/US01/13924

(51) Int. Cl. B05D 1/08; B32B 15/00

(52) U.S. Cl. 428/659; 427/446; 428/937; 428/933; 428/658

(57) ABSTRACT

A method for protection of submerged marine surfaces from bio-fouling which is carried out by spraying the surface to be protected with a solvent free, zinc or zinc based alloy coating produced by a thermal spray process.

### REFERENCE TO A RELATED APPLICATION

This application claims the benefit of the Provisional Application 60/201,306 which is relied on and incorporated herein by reference.

### INTRODUCTION AND BACKGROUND

The invention is a system comprised of metallized coatings and thermal spray procedures that produces a unique protective coating. In particular, the invention consists of preparing and applying zinc and zinc-based alloys. These materials are thermal sprayed with unique metallizing processes and procedures onto surfaces of submerged marine structures. This invention differs from other metallized coatings in that it performs the function of bio-fouling protection and cathodic protection.

The practice of coating steel and concrete with thermally sprayed metal coatings for corrosion protection has been accepted for many years for use on offshore platforms, oil storage tanks, gas transmission facilities, bridges, rail cars, locks and dams, bulkheads, ships, barges, pulp and paper mills, and petrochemical plants. Thermal spray coatings are often called metallized coatings. Many metals and alloys exist; aluminum and zinc are the most widely used metals for corrosion control. Aluminum metallized coatings (AMC) and zinc metallized coatings (ZMC) provide long-term corrosion protection for greater than 30 years. Compared to paint, both AMC and ZMC have superior corrosion and abrasion resistance.

Aluminum and zinc are anodic to most metals and protect these more noble substrates in electrolytic environments. Aluminum is more noble than zinc; therefore, it corrodes less rapidly than zinc. As a result, aluminum metallized coatings are more commonly used for corrosion protection in marine environments, rather than zinc metallized coatings. This is especially the case for immersion applications. Since the aluminum metallized coating will corrode less rapidly than zinc, AMC has been the standard choice for submerged, splash zone, and above water marine applications.

Thermal spray coatings have been used for corrosion protection on steel structure since the early 1900's. More recently, zinc metallized coatings are applied directly to the reinforced concrete surface to prevent future corrosion of the rebar. Highway bridges, parking garages, and other concrete structures can be protected using these (CP) cathodic protection systems. Zinc is the choice metal for cathodic protection, because it is one of the least noble metals and is compatible with concrete. When zinc is in bimetallic contact with steel in an electrolyte, the zinc will corrode or “sacrifice itself” and provide a level of protection to the more noble metal. The contact may be direct or indirect.

Purpose of Ani-Fouling Coatings

Marine animals and plant life accumulate on submerged surfaces located in intertidal regions. In the marine industry, this is referred to as fouling or bio-fouling. Barnacles and other fouling organisms are serious problems for owners of boats, ships, industrial facilities, buoys, power stations, etc. who keep their property in the intertidal region. This is referred to as hard fouling. Anti-fouling paints are designed to prevent fouling for a defined period of time. Owners who keep their property in the water year-round are faced with hauling, scraping, and painting on a routine basis. The present invention prevents hard fouling on submerged surfaces. It does not claim to prevent soft fouling like algae and slime.

Environmental Demand for Alternative Anti-Fouling Coatings

It has been recognized that a threat is placed on the earth's environment through the use of two types of antifouling paints: 1) paints containing tributyltin (TBT) and 2) paints containing copper or cuprous oxide.

Butyltins are organic tin compounds. Tributyltin is a butyltin compound. For decades, TBT has been put in marine paints to inhibit the growth of unwanted organisms such as algae and barnacles. A small amount of TBT is potent enough to kill aquatic life. When TBT paint is applied to ship hulls and ship components, the TBT leaches or “dissolves” into the water. When it settles to the bottom of the water table, it poisons and may kill marine life. Strong scientific evidence links TBT to adverse biological effects in fish and shellfish. Recent studies indicate that TBT and other butyltin compounds are causing deaths in sea mammals.

There is continuing evidence that TBT is dangerous to humans. Two Murray State University chemists conducted a study on human adults. The study showed that butyltin disrupts the function of critical human immune cells. Butyltins are the same compounds found in anti-fouling paints, wood preservatives, and dish sponges. The Murray State study found that when humans were exposed to “environmentally relevant” concentrations of tributyltin for as little as an hour the tumor-killing ability of natural killer cells was inhibited.

Many European countries have already issued a complete ban on TBT use in marine coatings. The United Nations International Marine Organization has issued resolutions to issue legally binding legislation by 2003. The legislation will globally prohibit the use of anti-fouling systems that contain organotins such as tributyltin. Despite the evidence that TBT is harmful to humans and marine life, it is not banned in the United States. Shipyards can apply TBT paints to large commercial vessels, but it is banned on smaller boats. Special licensing permits are required for applying TBT paints. Releases of TBT are limited through the issuance of state permits . Shipyards are required to comply with these levels. In short, TBT paints have provided a solution to boat owners but at an extreme expense to the environment, marine life and possibly humans. The environmental and health hazards of TBT are issuing a call for alternatives, and the political response to ban the use of TBT in marine paints creates a demand for proven antifouling coatings without environmental hazards.

The present invention contains no pesticides, biocides, or tributyltin. Since this product is a thermal spray coating, it contains no solvents or volatile organic compounds (VOCs). This is an important distinction from anti-fouling paints. Most of the solvents in these paints contain chemicals that are listed by the US Environmental Protection Agency as a hazardous material. Therefore, the production and use of these paints requires adherence to strict regulations because of the risk to health and safety of humans. When applied, liquid solvents in the paint coating evaporate. These solvents which contain VOC pose dangers to the atmosphere by ozone depletion. Furthermore, the containment, handling and disposal of the used paint cans and byproducts of the application process create several environmental problems.

Copper has been used heavily in the marine coatings industry. Eighteenth and nineteenth century wooden hull vessels were regularly clad with copper sheeting to prevent biofouling. Today, most antifouling paints contain high amounts of cuprous oxide. The US Navy and many scientific research organizations are investigating the release rates of copper from antifouling marine coatings. These organizations are issuing concerns about the possible damage copper is doing to the marine environment.

This invention includes the use of zinc-based metallized coatings to present hard fouling on submerged surface. Zinc-copper is one of the alloys selected for this invention. It can be stated, however, that the release rate of zinc, or copper or any of the metals on alloys used to form a metallized coating is much lower than that of a paint product, because the copper metal is only being released through oxidation. Paints contain copper salts that are soluble in water. Metallized coatings produced by this invention are insoluble in water. In fact, the metals or alloys used in this invention and thermal spray processes are insoluble in water.

### SUMMARY OF THE INVENTION

The primary purpose of this invention is to protect surfaces of submerged marine structures from bio-fouling and more particularly, hard fouling such as from barnacles.

More particularly, the present invention relates to a process for the protection of submerged marine structures in need of protection against hard fouling, such as barnacles because of the environment in which such marine structures are placed, for example in salt water. A second aspect of the invention relates to cathodic protection.

In carrying out this invention, a 100% metal coating is applied directly to the substrate. The coating is applied using a thermal spray process. The term metallizing is often used instead of thermal spray. The two terms are interchangeable. The present invention contains no solvents or volatile organic compounds (VOC). The coating is a zinc or zinc-based alloy. The coating is not designed as an ablative coating or self-polishing coating like other marine paints; therefore, minimal leaching of the coating into the water table occurs.

The purpose of this invention is to provide a coating system that performs better and is more desirable environmentally than conventional paint-systems that contain toxins or heavy metals. The coating of the present invention is comprised of zinc and zinc-based alloys. It contains no tributyltin (TBT), volatile organic compounds (VOC), pesticides, or biocides.

The coatings of this invention are intended to perform in conjunction with and more efficiently than other cathodic protection systems that require external electrical power supplies or sources. The present invention involves no external power supplies; therefore it involves less maintenance and repair than electrically impressed protection systems. An advantage of this invention is that the coating can be sprayed directly to the substrate. It provides a system more feasible and cost-effective than spraying copper-nickel to a resin insulating layer. Thermal sprayed zinc and zinc based alloys provide a more durable coating than a copper-nickel and resin coating system, because a metal-to-metal bond is stronger than a metal-to-resin bond. The present invention is a zinc-based coating sprayed directly to the surface of the marine structures and surfaces. The surface to be protected by this invention can be any surface which needs protection from fouling, including but not limited to steel aluminum, brass, stainless steel, concrete, fiberglass, plastic, and wood.

The present invention provides a cost-effective way to perform all stated functions, essentially to provide a commercially feasible application process for industries including, but not limited to, pleasure craft, oil and gas, power generation, shipping, petro chemical, paper and pulp, aids to navigation, and water treatment facilities. Thus, the present invention provides protection for structures, including, but not limited to ship hulls and boat hardware (propellers, rudders, shafts, trim tabs, strainers, etc.), buoys, locks, dams, off-shore oil rigs, piers, wharfs, bulk heads, pipelines, seawater intakes.

In fulfilling its objectives, this invention avoids the problems associated with other coating systems. Current bio-fouling control techniques cause galvanic corrosion of the coated metal structure. For example, the present invention avoids galvanic corrosion problems caused when placing dissimilar metals like copper on or near steel or aluminum.

### DETAILED DESCRIPTION OF INVENTION

The steps, methods, and components of the invention are illustrated as follows. The surface metal is power washed with fresh, clean water to remove soluble salts and bulk biomass. Next, the metal surface is blasted to a suitable extent; for example to a white metal according to standard SSPC-SP-5. A suitable anchor-tooth profile is created for a thermal spray coating. For non-metal surface, such as concrete, fiberglass, plastic, composites, etc., other blasting techniques are required.

Next, a zinc-based metal wire is selected that is compatible with the substrate. The coating is then applied using a thermal spray process such as electric arc, combustion wire, or combustion powder. Electric arc is preferred. Uniform coverage is achieved by applying multiple layers of the coating and overlapping passes with the spray gun.

A sealer may be added to the thermal spray coating to provide additional benefits. Sealers for thermal spray coatings are used by those familiar with the art. The zinc-based metal wire is composed of 50-100% zinc. The remaining metals include, but are not limited to, copper, carbon, tin, nickel, aluminum, and magnesium.

Because the present invention involves the spraying of zinc-based alloys, it avoids the toxic problems associated with tributyltin paints and copper paints. In addition, zinc does not create galvanic corrosion when sprayed on steel or aluminum structures. The following metals are the most commonly used in the manufacture of marine structures or vessels: nickel, brass, bronze, stainless steel, and copper-nickel. Finally, zinc provides cathodic protection to submerged metallic marine structures.

A preferred method is to modify standard thermal spray procedures. The purpose of the modifications is to produce a harder and more durable coating when compared to normal corrosion control coatings and to produce superior protection against bio-fouling with the added bonus of cathodic protection. Thermal spray industry standards for air pressure and spray parameters such as spray voltages have been elevated to provide a coating that is better as an anti-foulant than other thermal spray coatings. The modification of industry standards improves the anti-fouling characteristics of the invention.

Another preferred method is to select thermal spray equipment that produces a spray of small particles. The inventor has found that spraying small particles produces a smoother and more desirable coating. The inventor has discovered that using equipment that sprays large particles can cause a courser, uneven coating. It should also be noted that in many ways, the technique and skill of the thermal spray technician is important to the quality of the coating. The inventor prefers the use of an electric-arc, twin wire system for applying the coating.

It is preferred to use a two wire system with arc spraying techniques. Thus, one of the wires may be zinc and the second wire can be zinc or copper, aluminum, tin, nickel or magnesium.

As mentioned above, copper is known to have anti-fouling characteristics. However, copper and copper-nickel alloys may create electrolysis problems. Copper and copper-nickel alloys will cause galvanic corrosion to aluminum and steel when the coating is damaged and exposes the less noble substrate in an electrolytic environment. The inventor's use of zinc and zinc-based alloys provides a better coating than copper and copper-nickel alloys for two reasons. First, zinc and zinc-based alloys are compatible with more surfaces than a copper or copper-nickel alloy. Second, in tests conducted by the inventor it was demonstrated that zinc metallized coatings performed better than copper metallized coatings. Performance was rated by ability to prevent hard fouling.

The present invention is durable in harsh marine environments. Resin-based paints craze and crack badly when left in the sun for an extended period of time. In addition, the anti-fouling characteristics of traditional point coatings are lost if the pain remains out of water for extended periods of time (30-90 days). Most resin-based paints use copper or cuprous-oxide as the active anti-fouling agent. Ultraviolet for extended out of water have no negative effect on the performance of zinc or zinc-based metallized coatings in accordance with the present invention.

The present invention also acts as a passive cathodic protection system. Since the invention is passive, it is easier to maintain and more economical than an impressed current cathodic protection system. It contains no expensive power supplies, reference cells, wiring, etcetera. The complexity of an active cathodic protection system males it more expensive and less reliable for the owner of the marine structure.

The coating system of the present invention protects surfaces of submerged marine structures, such as ship hulls, from bio-fouling with the additional characteristic of cathodic protection. Not only does the invention provide improved performance when compared to existing paint systems, the design is also cost-effective and commercially feasible. No insulating layers of paint are required with this invention. The zinc or zinc-based thermal spray coating can be applied directly to the substrate of the structure; therefore, it is more economical because it has fewer application steps.

The cathodic protection characteristics of this invention will also provide the owner of the vessel or structure with the added benefit of life-cycle cost savings by reducing the corrosion rate and consumption of zinc anodes. For example, structure owners routinely place zinc anodes on underwater metal surfaces to protect the dissimilar metal from corrosion. This invention when applied to components or sections of the structure will reduce the consumption rate of the structure's zinc anodes. In this event, the zinc metallized coating or zinc-based metallized coating works in concert with the zinc anodes. Certain outside factors uncontrolled by this invention may prevent this benefit. They include but are not limited to the amount of stray electrical current present on the vessel, the level of stray electrical fields in the surrounding water, and the manner in which electrical devices on or near the structure are wired.

The performance of paints on moving boat parts like propellers and shafts have been poor. Paints have failed due to their low adhesion characteristics. A boat owner with a propeller coated with a paint with low bond strength will find that the paint first starts to disbond and fall off around the outside perimeter of the blades. Due to the motion of propellers through the water and abrasion caused by solids in the water, the paint is eventually completely worn off the blades. This will allow the unprotected surface to be fouled. The bond strength of this invention is at least five times higher than that of paints. In addition, the expansion and contraction rate of the zinc and zinc-based metallized coating is similar to the base metals (brass, aluminum, steel, stainless steel to name a few). Therefore, this invention has superior protection because it adheres to the metal and will not crack, disbond, or come off as easily.

### EXAMPLES OF INVENTION

It was noted through many years of experience in cleaning and painting boat hulls that paint was effective for ten to sixteen months at best. After this period, it was found that the hull needed to be repainted. It was also noted that the hardware (propellers, shafts, rudders, struts, trim tabs, etc.) of the boat fouled more quickly than the hull. This problem was due to the limited bond strength of paint. Prop wash, movement of the boat through the water, and other actions caused the paint to prematurely come off. Thermal spray coatings offer at least five times the bond strength of paint. As a result of these observations, experiments were performed with metallized coatings. The inventor has extensive experience in thermal spray coatings used for corrosion protection and cathodic protection. The inventor also has experience cleaning and painting boat hulls.

This invention provides an entire coating system for cathodic protection.

### Example 1

A requirement for corrosion protection existed for a dive platform attached to a dive boat. Four carbon steel supports for the dive platform were coated. Since aluminum is the preferred metal for marine underwater corrosion protection, thermal sprayed aluminum was applied to all the supports except one which was coated with thermal sprayed zinc.

Based on the principles of galvanic corrosion, to those experienced in the art it was unconventional to place zinc in a marine underwater environment since zinc corrodes more quickly than aluminum. The results of this test were surprising and revealing in that the zinc-coated support did not corrode as quickly as expected and showed no signs of bio-fouling. In contrast, the aluminum-coated steel was badly corroded and fouled. This was caused by contact of the aluminum metallized coating and the copper-rich paint in an electrolyte. Severe electrolysis ensued by the dissimilar metals being in contact with one another. This caused the paint to peel further exposing the steel to marine growth. This caused the chain reaction that accelerated with time. Through this example it was discovered that two problems were solved—bio-fouling and corrosion protection—by using the ZMC. Further, the zinc even went beyond its initial, intended purpose by providing a third benefit: cathodic protection to the carbon steel support bracket.

### Example 2

Thermal sprayed zinc and zinc-based alloys were applied to aluminum propellers, brass propellers, aluminum samples, steel samples, and brass samples. Some propellers were placed on boats and others were placed in saltwater rivers and bays tributary to the Chesapeake Bay and Atlantic Ocean. It was concluded from these tests that zinc and zinc-based thermal spray coatings protect the base metal from bio-fouling, and galvanic corrosion.

### Example 3

### Test Propeller (Static)

A three-bladed brass propeller was coated with a copper/zinc metallized coating. Using a nylon rope, the propeller was hung into a saltwater tributary to the Chesapeake Bay. The propeller remained in the water for one full season (approximately four months). At the end of the season, the propeller was pulled out for analysis. A garden hose was used to remove the soft fouling on the propeller. The propeller had no barnacle growth or other hard fouling.

The tips of two of the propeller blades were cut off and submitted to a laboratory for analysis. The purpose of the analysis was to determine if the substrate was protected from corrosion. The laboratory took sections from the blade tips for analysis. These sections were mounted in epoxy resin and then polished. Using microscopy, the laboratory found that “there was no apparent attack or disorder in the parent metal.”

### Example 4

### Long Creek Test 2000-2001

Two 2″×2″ metal pieces were coated. The first piece was aluminum coated with a zinc metallized coating. The second piece was a brass piece coated with a copper-zinc metallized coating. These two samples were placed on string and hung alongside a dock. A third uncoated carbon steel sample was hung in the water with the coated samples. The dock is located on a saltwater creek that feeds into the mouth of the Chesapeake Bay. These three samples were exposed for one summer season (approximately four months).

The results showed no fouling or serious corrosion on the metallized samples. Surface oxidation was visible on the two coated samples. The good performance of these coatings contrasted with the untreated sample. The carbon steel was heavily corroded and delaminated. A few large barnacles and several small barnacle were also attached to the uncoated sample. The test reaffirmed the fouling results of the propeller test (Example 1).

### Example 5

### Test Float

On Jun. 26, 2000, a test float was placed at the same marina location mentioned in the above examples. The test float was made out of PVC piping. Twenty-six 2″×2″ metal samples were tied to the float using nylon string. The samples were made of steel, aluminum, brass, or stainless steel. Seven different metallized coatings were coated on each type of metal. The coatings included a zinc metallized coating and six zinc-based alloy metallized coatings. One uncoated sample of each metal was tied to the float as well.

The results of the tests are as follows:

1. The zinc metallized coating performed well on all substrates.

2. Depending on the substrate, the six zinc-based coatings varied in performance.

3. Overall, the test indicated that zinc and zinc-based metallized coatings perform well in preventing fouling.

4. It is important that the zinc or zinc-based alloy be correctly selected for each individual application.

### Example 6

### Two 24″ 3-Bladed Propellers 1998-2000

In November of 1998, two three-bladed propellers were coated for a boat docked on the Elizabeth River in Norfolk, Va. The owner of the boat uses the boat infrequently, so the propellers are often sitting still for several weeks at a time. This is a good test subject for testing the effectiveness of zinc and zinc-based alloy metallized coatings. Barnacles strike on metal and need time to adhere to the surface. If a boat is used regularly, then the barnacles are swept off the metal surfaces by the action or forward motion of the boat.

This boat was moored at the dock in Elizabeth River for two years. In December 2000, the boat was hauled out for the first time since November 1998. The propellers were free from heavy fouling except for a few small barnacles around the hub of the propeller. Under normal conditions, the owner stated that the propellers would have been entirely coated with barnacles. Due to the customer's satisfaction with the results, he asked the inventor to apply the same metallized coating to the boat shafts, struts, rudders and trim tabs. The inventor mobilized a crew to the boat yard and provided the service.

### Example 7

### Zinc Anodes on Two Shafts Connected to Two 24″ 3-Bladed Propellers (Same Propellers as Described in Example 6)

The boat described in Example 6 is not only an example of the anti-fouling characteristics of the invention, it is also an example of the cathodic protection provided by the invention.

The shafts on this boat were stainless steel. The propellers were brass. To protect the less noble propeller material from corrosion, the boat owner placed one zinc anode on each of the shafts. The zinc anodes on the shaft of this boat were in excellent condition after two years of use. The anode held its original shape and was only slightly depleted. The boat owner stated that prior to 1998 and under the same marina conditions, the boat's anodes would be completely depleted in less than two years.

Typically, boat owners in the Chesapeake Bay region can expect their zinc anodes to require replacement at least once per year. This example demonstrates the cathodic protection offered by this invention in submerged marine environments.

Further variations and modifications of the foregoing will be apparent to those skilled in the art and are intended to be encompasses by the claims appended hereto.

1. A method for protection of submerged marine surfaces from bio-fouling without external electrical power comprising:
spraying the surface to be protected with a solvent free, zinc or zinc based alloy coating produced by a thermal spray process.

2. The method according to claim 1 wherein the coating is free of tributytin.

3. The method according to claim 1 wherein said spraying is in the absence of a volatile organic compounds (VOC).

4. The method according to claim 1 wherein the surface is a metal member selected from the group consisting of carbon steel, aluminum, stainless steel, brass, copper, copper-nickel, monel, lead and bronze.

5. The method according to claim 1 wherein the coating is applied directly to the surface of the structure without any insulating layers.

6. The method according to claim 1 wherein the surface is fiberglass, plastic, composites, concrete, or wood.

7. The method for protecting of a submerged metal marine surface without external electrical power comprised of washing the surface to be protected with water to remove any soluble salts and biomass, blasting the metal surface to white metal, selecting a metal wire containing zinc compatible with said surface, carrying out a thermal spray process to apply zinc or zinc based coating to said surface to thereby achieve protection against bio-fouling.

8. The method according to claim 4 wherein said thermal spray process is by electric arc, combustion wire or combustion powder.

9. The method according to claim 7 further comprising applying multiple layers by thermal spray to obtain a uniform coverage by the zinc or zinc based alloy on the said surface.

10. The method according to claim 4 further comprising optionally adding a sealer on top of the thermal spray coating.

11. The method according to claim 1 wherein a thermal spray metallized coating is deposited and composed of 50-100% zinc.

12. The method according to claim 9 wherein zinc metal coating additionally contains a member selected from the group consisting of copper, carbon, tin, nickel, aluminum, magnesium and mixtures thereof.

13. A method for cathodically protecting surfaces of marine structures which are to be placed underwater comprising thermally spraying said surfaces with a solvent free, zinc or zinc based alloy coating.

14. The method according to claim 12 wherein said marine structure is the hull of a ship, ship hardware, buoys, locks, dam, off-shore oil rigs, piers, wharfs bulk heads, pipelines and sea water intakes.

15. A marine structure which when in use is submerged in water having been coated by the method according to claim 1.

16. A marine structure has been coated according to the method of claim 13.

17. A propeller having been coated by the method of claim 1.

18. A submerged marine surface coated with the method according to claim 1.
